(19) United States
(12) Patent Application Publication
(10) Pub. No.: US 2020/0293254 A1
(43) Pub. Date: Sep. 17, 2020

(54) DISPLAY INFORMATION GENERATION DEVICE AND NON-TRANSITORY COMPUTER READABLE MEDIUM STORING PROGRAM

(71) Applicant: FUJI XEROX CO., LTD., Tokyo (JP)

(72) Inventor: Ami KANZAKI, Kanagawa (JP)

(73) Assignee: FUJI XEROX CO., LTD., Tokyo (JP)

(21) Appl. No.: 16/529,739

(22) Filed: Aug. 1, 2019

(30) Foreign Application Priority Data
Mar. 14, 2019 (JP) 2019-047228

(51) Int. Cl. G06F 3/14; G06F 3/0482; G06F 3/12

(52) U.S. Cl. CPC G06F 3/14; G06F 3/126; G06F 3/1205; G06F 3/0482

(57) ABSTRACT

A display information generation device includes a specifying section that specifies plural features that each device of plural devices has; and a generation section that generates display information for displaying a specific feature that at least one device other than each device does not have, among the plural features that each device has, in association with each device of the plural devices.

### CROSS-REFERENCE TO RELATED APPLICATIONS

This application is based on and claims priority under 35 USC 119 from Japanese Patent Application No. 2019-047228 filed Mar. 14, 2019.

### BACKGROUND

### (i) Technical Field

The present invention relates to a display information generation device, and a non-transitory computer readable medium storing a program.

### (ii) Related Art

An information processing system is known which reads out order identification information from a printed print request slip, analyzes the read order identification information to generate and register print setting structure information for specifying an information processing apparatus that is to process the received print order, determines one of the information processing apparatuses printed on a sheet printed based on the registered print setting structure information and the resource information of each information processing apparatus, as a recommended information processing apparatus, and displays the determined recommended information processing apparatus on a screen (see, for example, JP2016-058040A).

There is also known an information processing apparatus provided with a printer information analysis unit that acquires resource information of a printer, a job ticket analysis unit that acquires setting information from a job ticket, and a determination rule collating unit that compares resource information with setting information to determine whether or not a working time of a print preparation process related to job execution for each printer can be shortened, and calculates the recommendation degree of the printer (see, for example, JP2017-084035A).

### SUMMARY

In a configuration that only recommends devices satisfying the conditions necessary to execute a specific process, it is not possible to notify differences in features between the devices in a case where there are plural corresponding devices.

Aspects of non-limiting embodiments of the present disclosure relate to a display information generation device, and a non-transitory computer readable medium storing a program, which enable notification of differences in features between plural devices.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided. a display information generation device including a specifying section that specifies a plurality of features that each device of a plurality of devices has; and a generation section that generates display information for displaying a specific feature that at least one device other than each device does not have, among the plurality of features that each device has, in association with each device of the plurality of devices.

### BRIEF DESCRIPTION OF THE DRAWINGS

Exemplary embodiment (s) of the present invention will be described in detail based on the following figures, wherein:

FIG. 1 is a diagram showing an example of an overall configuration of a computer system according to an exemplary embodiment of the present invention;

FIG. 2 is a diagram showing an example of a hardware configuration of a server according to the exemplary embodiment of the present invention;

FIG. 3 is a block diagram showing an example of a functional configuration of the server according to the exemplary embodiment of the present invention;

FIG. 4 is a flowchart showing an operation example of the server in a case of generating display information for realizing initial display contents according to the exemplary embodiment of the present invention;

FIG. 5 is a flowchart showing an operation example of the server in a case of generating display information for realizing display contents when selecting a candidate device according to the exemplary embodiment of the present invention;

FIG. 6 is a diagram showing a specific example of definition information stored in advance in a definition information storage unit in the first example of the present invention;

FIG. 7 is a diagram showing a specific example of feature information initially stored in a feature information storage unit in the first example of the present invention;

FIG. 8 is a diagram showing a specific example of feature information stored in the feature information storage unit after a process of ranking or a process of leaving “presence” is performed in the first example of the present invention;

FIG. 9 is a diagram showing an example of initial display contents of a print instruction screen displayed on the client in the first example of the present invention;

FIG. 10 is a diagram showing an example of display contents when selecting a first printing device on the print instruction screen displayed on the client in the first example of the present invention;

FIG. 11 is a diagram showing an example of display contents when selecting a second printing device on the print instruction screen displayed on the client in the first example of the present invention;

FIG. 12 is a diagram showing a specific example of definition information stored in advance in a definition information storage unit in a second example of the present invention;

FIG. 13 is a diagram showing a specific example of feature information initially stored in a feature information storage unit in the second example of the present invention;

FIG. 14 is a diagram showing a specific example of feature information stored in the feature information storage unit after a process of ranking is performed in the second example of the present invention;

FIG. 15 is a diagram showing an example of initial display contents of a search result screen displayed on the client in the second example of the present invention;

FIG. 16 is a diagram showing an example of display contents when selecting a smartphone on the search result screen displayed on the client in the second example of the present invention; and

FIG. 17 is a diagram showing an example of display contents in which an appeal function of the search result screen displayed on the client is emphasized, in the second example of the present invention.

### DETAILED DESCRIPTION

Hereinafter, an exemplary embodiment of the present invention will be described in detail with reference to the accompanying drawings.

Overview of the Present Exemplary Embodiment

In the present exemplary embodiment, display information is generated for displaying a specific feature that at least one device other than each device does not have, among plural features that each device has, in association with each device of plural devices.

In the following, a description will be made to a case of narrowing down to devices capable of executing a process requested from plural devices or candidate devices that satisfy the minimum required condition, and displaying a difference between the candidate devices in a case where there are plural candidate devices. Hereinafter, devices before narrowing down to devices capable of executing a process requested or devices that satisfy the minimum required condition are referred to as “target devices”, and devices that are candidates after narrowing down are referred to as “candidate devices”.

Overall Configuration of Computer System

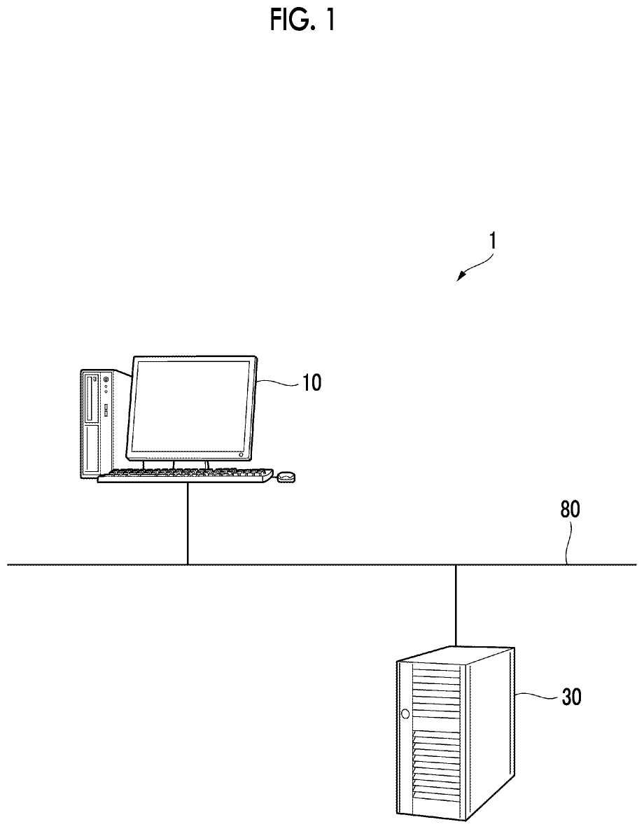

FIG. 1 is a diagram showing an example of an overall configuration of a computer system 1 to which the present exemplary embodiment is applied. As illustrated, the computer system 1 is configured by connecting a client 10 and a server 30 to a communication line 80. Although only one client 10 is shown in FIG. 1, two or more clients 10 may be provided.

The client 10 is a computer that transmits information to the server 30, and displays a difference (strength or weakness) among plural candidate devices based on the display information, in a case of receiving display information from the server 30 according to the information. For example, in a case where the candidate device is a printing device, an application for creating data to be printed and a printer driver for creating print instruction information for instructing printing of the data to be printed are installed, and in a case where the printer driver transmits print instruction information to the printing device, the difference between the printing devices is displayed. In a case where the candidate device is a terminal device, a browser for browsing information on the Internet is installed, and in a case where the user searches for information on the terminal device using this browser, a difference between the terminal devices may be displayed. Here, as the client 10, a PC, a portable terminal or the like may be used.

The server 30 is a computer that generates display information for displaying differences between plural candidate devices, in a case of receiving information from the client 10, and transmits the display information to the client 10. For example, in a case where the candidate device is a printing device, the server 30 acquires feature information of each printing device of plural printing devices, and generates display information for displaying a difference between the pieces of feature information. In this case, the plural printing devices may be connected to the communication line 80, and the server 30 may acquire the feature information from each printing device of the plural printing devices through the communication line 80. In a case where the candidate device is a terminal device, the server 30 acquires feature information of each terminal device of plural terminal devices, and generates display information for displaying the difference between the pieces of feature information. In this case, at least one computer managing feature information of each terminal device of the plural terminal devices is connected to the communication line 80, and the server 30 may acquire the feature information of each terminal device of the plural terminal devices from the at least one computer through the communication line 80.

The communication line 80 is a communication means used for information communication between the client 10 and the server 30. As the communication line 80, for example, a local area network (LAN) or the Internet may be used.

Although a system aspect in which the client 10 has the function of the server 30 may be considered, here, as an example, a system aspect in which the client 10 and the server 30 are divided is assumed to be described.

Hardware Configurations of Client and Server

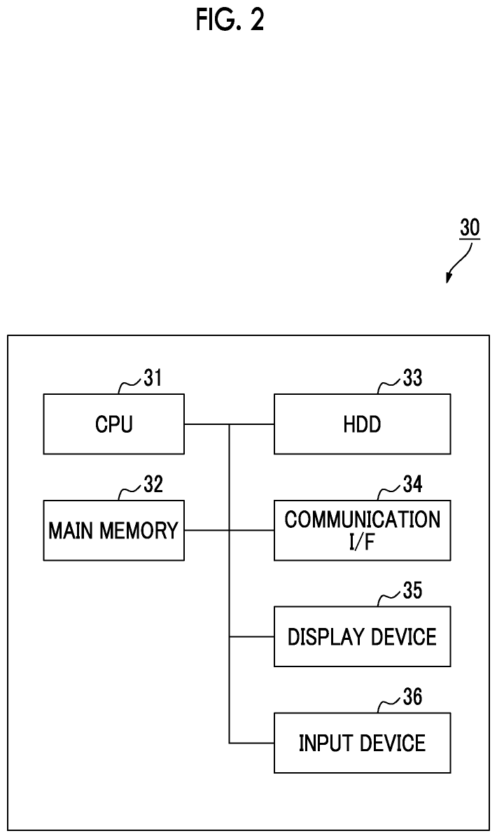

FIG. 2 is a diagram showing an example of a hardware configuration of the server 30 according to the present exemplary embodiment. As illustrated, the server 30 includes a CPU 31 which is an arithmetic unit, and a main memory 32 and a hard disk drive (HDD) 33 which are storage units. Here, the CPU 31 executes various software such as an operating system (OS) and an application to realize each function described later. The main memory 32 is a storage area for storing various software and data used for the execution, and the HDD 33 is a storage area for storing input data for various software, output data from various software, and the like. Further, the server 30 includes a communication I/F 34 for communicating with the outside, a display device 35 such as a display, and an input device 36 such as a keyboard and a mouse.

The hardware configuration shown in FIG. 2 can also be regarded as the hardware configuration of the client 10. However, when describing the client 10, it is assumed that the CPU 31, the main memory 32, the HDD 33, the communication I/F 34, the display device 35, and the input device 36 in FIG. 2 are respectively described as a CPU 11, a main memory 12, a HDD 13, a communication I/F 14, a display device 15, and an input device 16.

Functional Configuration of Server

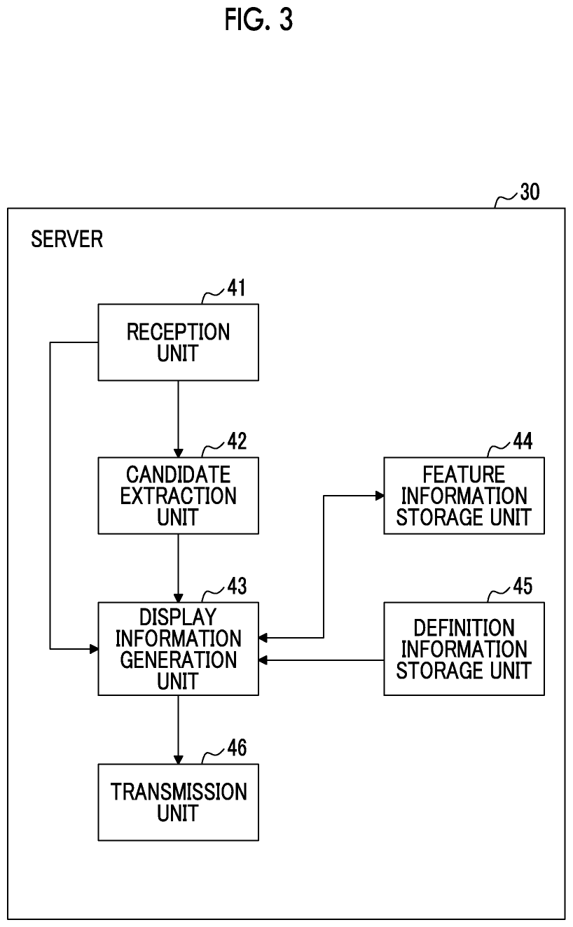

FIG. 3 is a block diagram showing an example of a functional configuration of the server 30 according to the present exemplary embodiment. As illustrated, the server 30 in the present exemplary embodiment includes a reception unit 41, a candidate extraction unit 42, a display information generation unit 43, a feature information storage unit 44, a definition information storage unit 45, and a transmission unit 46.

The reception unit 41 periodically receives feature information of each target device from plural target devices or a computer that manages the target devices, receives instruction information for instructing processing related to the target device from the client 10, and outputs the feature information and the instruction information to the candidate extraction unit 42.

In a case where the target device is a printing device, the feature information of each printing device is received from each of the plural printing devices, and the printing instruction information for instructing printing in any of the plural printing devices is received as the instruction information.

In a case where the target device is a terminal device, the feature information of each terminal device is received from at least one computer each managing at least one of the plural terminal devices, or the search instruction information for instructing the search of the terminal device satisfying the condition from the plural terminal devices is received as instruction information.

Further, the reception unit 41 receives, from the client 10, selection information indicating a device selected from the devices displayed on the client 10, and outputs the selection information to the display information generation unit 43.

The candidate extraction unit 42 periodically receives feature information from the reception unit 41, and retains the feature information. Then, in a case where the instruction information is received from the reception unit 41, plural candidate devices are extracted from plural target devices, based on the retained feature information. Then, the feature information of each candidate device of the plural candidate devices extracted is output to the display information generation unit 43.

In a case where the target device is a printing device, a printing device capable of printing based on the print instruction information received from the reception unit 41 is extracted as a candidate device, based on the retained feature information. For example, in a case where the print instruction information instructs color printing, a printing device having feature information indicating that color toner is loaded may be extracted as a candidate device. In a case where the print instruction information instructs printing on a special sheet, a printing device having feature information indicating that the special sheet is loaded may be extracted as a candidate device. In a case where the print instruction information instructs the post-processing in addition to the printing, a printing device having feature information indicating that the post-processing apparatus that performs the post-processing is connected may be extracted as a candidate device. Alternatively, regardless of the content of the print instruction information, a printing device having feature information indicating that the printing device is in failure may be excluded from the candidate devices.

In a case where the target device is a terminal device, a terminal device that matches the search instruction information received from the reception unit 41 is extracted as a candidate device, based on the retained feature information. For example, in a case where the search instruction information is for instructing a search by “notebook PC” or “15 inches”, a notebook PC having feature information indicating that the size is 15 inches is extracted as a candidate device. Further, in a case where the search instruction information is for instructing a search by “smartphone”, “face authentication support”, “wireless charging”, a smartphone having feature information indicating that it corresponds to face authentication and wireless charging is possible may be extracted as a candidate device.

In the present exemplary embodiment, plural candidate devices are used as an example of plural devices, feature information is used as an example of plural features which each device of the plural devices has, and the reception unit 41 is provided as an example of a specifying section that specifies plural features.

In a case of receiving the feature information of each candidate device of the plural candidate devices from the candidate extraction unit 42, the display information generation unit 43 stores the feature information not common among the plural candidate devices in the feature information storage unit 44.

Further, the display information generation unit 43 generates display information for realizing a display content which is an initial display content of the screen based on the instruction information, and includes feature information satisfying the condition defined in the definition information storage unit 45, among the pieces of feature information stored in the feature information storage unit 44. At that time, in a case where the condition defined in the definition information storage unit 45 indicates a favorable feature, display information for realizing the display content including the feature information satisfying the condition in a mode indicating the favorable feature is generated. In a case where the condition defined in the definition information storage unit 45 indicates an unfavorable feature, display information for realizing the display content including the feature information satisfying the condition in a mode indicating that the unfavorable feature is generated.

In a case where the candidate device is a printing device, display information for realizing a display content which is an initial display content of a print instruction screen for instructing printing based on print instruction information and includes feature information satisfying the conditions defined in the definition information storage unit 45, among the pieces of feature information stored in the feature information storage unit 44 is generated.

In a case where the candidate device is a terminal device, display information for realizing a display content which is an initial display content of a search result screen indicating the s result by the search instruction information and includes feature information satisfying the conditions defined in the definition information storage unit 45, among the pieces of feature information stored in the feature information storage unit 44 is generated.

In a case where the states of plural target devices change and the candidate device extracted by the candidate extraction unit 42 changes, the display content including the feature information also dynamically changes. Further, display information generation unit 43 may generate display information for visually notifying the recommended candidate device by animation.

Further, in a case of receiving selection information indicating a candidate device selected on the screen based on the instruction information from the reception unit 41, the display information generation unit 43 generates display information for realizing a display content which is a display content when selecting a candidate device on the screen based on the instruction information, and includes feature information satisfying the condition defined in the definition information storage unit 45, among the pieces of feature information stored in the feature information storage unit 44. At that time, in a case where the condition defined in the definition information storage unit 45 indicates a favorable feature, display information for realizing the display content including the feature information satisfying the condition in a mode indicating that the favorable feature is generated. In a case where the condition defined in the definition information storage unit 45 indicates an unfavorable feature, display information for realizing the display content including the feature information satisfying the condition in a mode indicating the unfavorable feature information is generated. In addition, at that time, in a case where the feature information satisfying the condition defined in the definition information storage unit 45 is the feature information of the unselected candidate device, display information for realizing the display content including the feature information in the form of a difference with respect to the feature information of the selected candidate device is generated.

In a case where the candidate device is a printing device, display information for realizing a display content which is the display content when selecting the printing device on a print instruction screen for instructing printing based on print instruction information and includes feature information satisfying the conditions defined in the definition information storage unit 45, among the pieces of feature information stored in the feature information storage unit 44 is generated.

In a case where the candidate device is a terminal device, display information for realizing a display content which is the display content when selecting the terminal device on a search result screen indicating the search result by the search instruction information and includes feature information satisfying the conditions defined in the definition information storage unit 45, among the pieces of feature information stored in the feature information storage unit 44 is generated.

In a case where the states of plural target devices change and the candidate device extracted by the candidate extraction unit 42 changes, the display content including the feature information also dynamically changes. Further, display information generation unit 43 may generate display information for visually notifying the recommended candidate device by animation.

In the present exemplary embodiment, the display information generation unit 43 is provided as an example of a generation section that uses feature information not common among plural candidate devices as an example of a specific feature that at least one device other than each device does not have, and generates display information for displaying the specific feature in association with each device of the plural devices.

Further, the display information generation unit 43 is provided as a generation section that generates display information for displaying a feature satisfying a condition predetermined as a condition indicating a favorable feature, in a mode predetermined as a mode indicating the favorable feature, or a generation section that generates display information for displaying a feature satisfying a condition predetermined as a condition indicating an unfavorable feature, in a mode predetermined as a mode indicating the unfavorable feature.

Further, the selected candidate device is used as an example of a specific device of the plural devices, an unselected device is used as an example of another device other than the specific device, and a difference between the feature information of the selected candidate device and the feature information of the unselected candidate device is used as an example of a difference between the numerical value representing the state, the performance, or the specification that the other device has and the numerical value representing the state, the performance, or the specification that the specific device has. Further, the display information generation unit 43 is provided as an example of a generation section that generates display information for displaying a difference in association with another device in a case where a specific device is selected.

The feature information storage unit 44 stores feature information not common among plural candidate devices by the display information generation unit 43. In the following, feature information is assumed to be information including feature items and feature values. In a case where the feature item is an item indicating a state, performance, or specification, a numerical value representing the state, performance, or specification is stored as the feature value. In a case where the feature item is an item indicating a function, “presence”, “none” or the type of the function is stored as the feature value.

In a case where the candidate device is a printing device, among the feature items, the items indicating the state are, for example, “printing completion time”, “remaining amount of paper”, and “use time”, and the items indicating performance are, for example, “printing time”, “failure rate”, and “jam rate”. Further, among the feature items, items indicating functions are, for example, “gold/silver toner”, “thick paper”, and “use stock”.

In a case where the candidate device is a terminal device, among the feature items, an item indicating a state is, for example, “battery run time”, and an item indicating a specification is, for example, “weight”. Further, among the feature items, items indicating functions are, for example, “video shooting”, “display”, and “screen operation”.

Further, in a case where the display information generation unit 43 executes a process of ranking numerical values which are feature values in a case where the feature item is a state, performance, or specification, and types of functions which are feature values in a case where the feature item is a function, the feature information storage unit 44 also stores ranking in association with the feature value for each feature item. Further, after the display information generation unit 43 executes a process of leaving only “presence” which is the feature value in a case where the feature item is a function, “none” of the feature value is not stored.

The definition information storage unit 45 stores the ranking definition that defines a method of assigning a ranking to a numerical value that is a feature value in a case where the feature item is an item indicating a state, performance, or specification, or a function type that is a feature value in a case where the feature item is an item indicating a function. Here, examples of the ranking method include a method of assigning a higher ranking to the larger numerical value which is a feature value in a case where the feature item is an item indicating a state, performance, or a specification, and a method of assigning a higher ranking to the smaller numerical value. Alternatively, for example, there is a method of assigning a higher ranking to a better function type which is a feature value in a case where the feature item is an item indicating a function.

Further, the definition information storage unit 45 stores an initial display condition definition that defines conditions regarding feature information included in the initial display content of the screen based on the instruction information. Further, the selection display condition definition is stored that defines conditions regarding feature information included in the display content when selecting the candidate device on the screen based on the instruction information. Here, as the condition regarding feature information defined in the initial display condition definition or the selection display condition definition, a condition is exemplified that rankings assigned to numerical values which are feature values in a case where the feature item is a state, performance, or specification, and rankings assigned to types of functions which are feature values in a case where the feature item is a function are the highest or lowest. Alternatively, a condition is also illustrated that the feature value in a case where the feature item is a function is “presence”.

Among the conditions, the condition that the ranking is the highest is an example of a condition predetermined as a condition indicating a favorable feature. The condition that the ranking is the lowest is an example of a condition predetermined as a condition indicating an unfavorable feature.

In addition, in a case where the feature item is an item indicating a state, performance, or a specification, in a case of the method of assigning a higher ranking to a larger numerical value that is the feature value, the condition that the ranking is the highest is an example of a condition predetermined as a condition indicating that the numerical value representing the state, the performance, or the specification is large. In a case of the method of assigning a higher ranking to a smaller numerical value that is the feature value, the condition that the ranking is the highest is an example of a condition predetermined as a condition indicating that the numerical value representing the state, the performance, or the specification is small.

In addition, in a case where the feature item is an item indicating a state, performance, or a specification, in a case of the method of assigning a higher ranking to a larger numerical value that is the feature value, the condition that the ranking is the lowest is an example of a condition predetermined as a condition indicating that the numerical value representing the state, the performance, or the specification is small. In a case of the method of assigning a higher ranking to a smaller numerical value that is the feature value, the condition that the ranking is the lowest is an example of a condition predetermined as a condition indicating that the numerical value representing the state, the performance, or the specification is large.

Further, in a case where the feature item is an item indicating a function, the condition that the ranking assigned to the type of function that is the feature value is the highest or lowest is an example of the condition regarding the type of function. The condition that the feature value is “presence” is an example of the condition having a function.

The transmission unit 46 transmits the display information generated by the display information generation unit 43 to the client 10.

Server Operation

In the server 30, first, the reception unit 41 periodically receives feature information of each target device of plural target devices, and the candidate extraction unit 42 holds the feature information. On the other hand, the reception unit 41 receives instruction information from the client 10, and the candidate extraction unit 42 extracts plural candidate devices, based on the instruction information and the held feature information. Then, the candidate extraction unit 42 notifies the display information generation unit 43 of the plural extracted candidate devices.

Then, the display information generation unit 43 generates display information for realizing the initial display contents of the screen based on the instruction information.

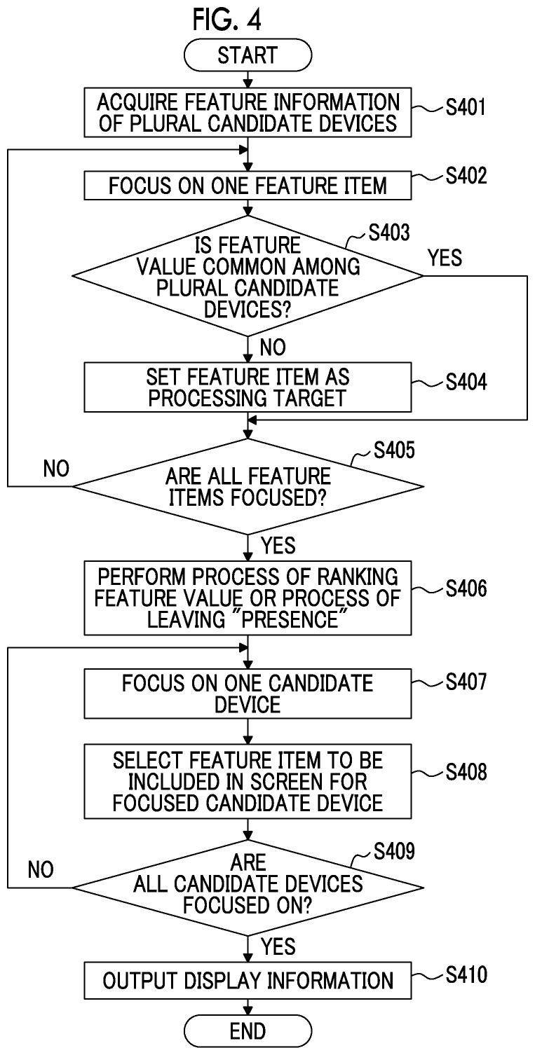

FIG. 4 is a flowchart showing an operation example of the display information generation unit 43 at this time.

First, the display information generation unit 43 acquires feature information of each candidate device of plural candidate devices from the candidate extraction unit 42 (step S401).

Next, the display information generation unit 43 focuses on one feature item of the feature information (step S402). Then, for this focused feature item, it is determined whether or not the feature value is common among plural candidate devices (step SS 403).

In a case where it is determined that the feature value is not common among the plural candidate devices, the display information generation unit 43 sets this feature item as a processing target (step S404). That is, the feature value of each candidate device for the feature item is stored in the feature information storage unit 44. Then, the process proceeds to step S405.

On the other hand, in a case where it is determined that the feature value is common among the plural candidate devices, the display information generation unit 43 excludes this feature item from the processing target. That is, the process proceeds to step S405, without performing step S404 for this feature item.

Thereafter, the display information generation unit 43 determines whether or not all the feature items of the feature information are focused in step S402 (step S405). In a case where it is determined that there is a feature item that is not focused on, the display information generation unit 43 returns the process to step S402. Further, in a case where it is determined that all feature items are focused on, the display information generation unit 43 makes the process proceed to step S406.

At this time, the feature information storage unit 44 stores feature information in which the feature value for each candidate device is associated with the feature item whose feature value is not common among the plural candidate devices.

Next, the display information generation unit 43 performs a process of ranking the feature values or a process of leaving “presence” of the feature values for all the feature items stored in the feature information storage unit 44 (step S406). Specifically, in a case where the feature item is an item indicating a state, performance or specification, and the feature value is represented by a numerical value, the numerical value is ranked. In a case where the feature item is an item indicating a state, performance, or specification, the definition information storage unit 45 stores ranking definition defining for each feature item whether the larger the numerical value of the feature value, the higher the rank, or the smaller the numerical value, the higher the rank, so the display information generation unit 43 ranks the feature value with reference to the ranking definition. In addition, in a case where the feature item is an item indicating a function, and the feature value is represented by “presence” or “none”, “none” is deleted.

Next, the display information generation unit 43 focuses on one candidate device among the plural candidate devices (step S407). Then, the feature items to be included in the screen are selected for the focused candidate device (step S408). Specifically, since the initial display condition definition which defines the condition regarding the feature value for including the feature item on the screen is stored in the definition information storage unit 45, the feature items are selected with reference to the initial display condition definition. For example, in a case where the feature item is an item indicating a state, performance or specification, it is conceivable to include feature items having the feature values of the highest or lowest ranking. In addition, in a case where the feature item is an item indicating a function, it is conceivable to include the feature items having the feature value of “presence”. As a result, display information for realizing a display content which is the initial display content of the screen based on the instruction information and includes the feature item selected for the focused candidate device is generated.

Thereafter, the display information generation unit 43 determines whether or not all candidate devices are focused on in step S407 (step S409). In a case where it is determined that there is a candidate device that is not focused on, the display information generation unit 43 returns the process to step S407. Further, in a case where it is determined that all candidate devices are focused on, the process proceeds to step S410.

Finally, the display information generation unit 43 outputs the display information generated in step S408 so far to the transmission unit 46 (step S410), and ends the process.

Then, the transmission unit 46 transmits the display information to the client 10. Then, based on the display information, the client 10 realizes initial display content of the screen based on the instruction information.

In a state where such a screen is displayed on the client 10, it is assumed that the user selects one candidate device of the plural candidate devices included in the screen. Thus, in the server 30, the reception unit 41 receives selection information indicating the selected candidate device, and transmits the selection information to the display information.

Then, the display information generation unit 43 generates display information for realizing the display contents when selecting a candidate device of the screen based on the instruction information.

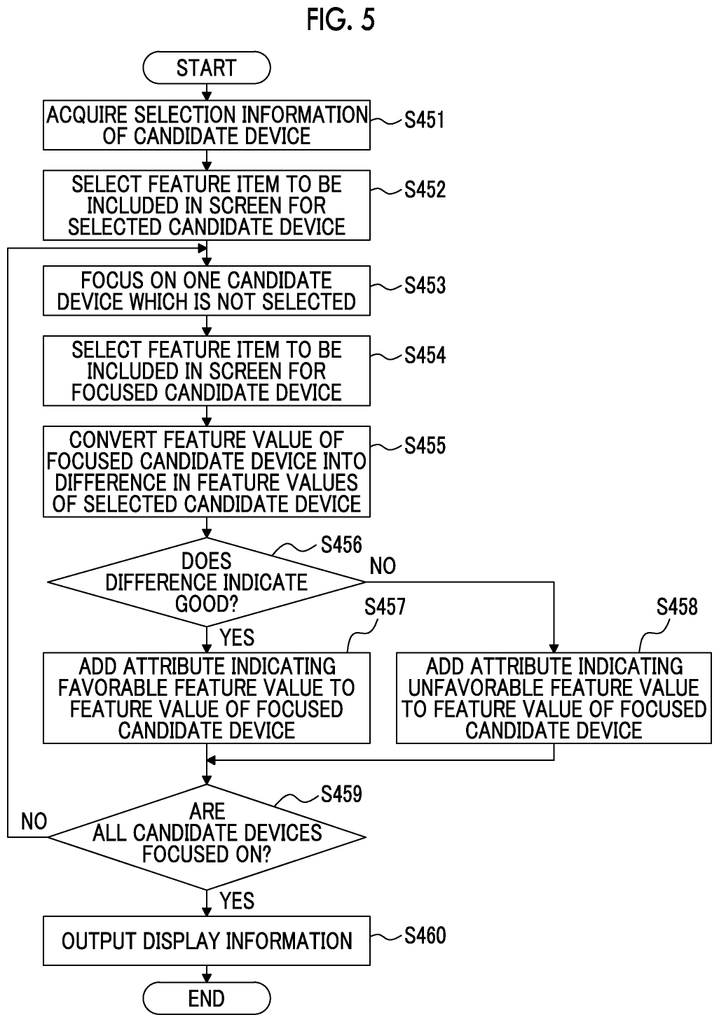

FIG. 5 is a flowchart showing an operation example of the display information generation unit 43 at this time.

First, the display information generation unit 43 acquires selection information of candidate devices from the reception unit 41 (step S451).

Next, the display information generation unit 43 selects feature items to be included in the screen, for the selected candidate devices (step S452). Specifically, since the selection display condition definition which defines the condition regarding the feature value for including the feature item on the screen is stored in the definition information storage unit 45, the feature item is selected with reference to the selection display condition definition. For example, in a case where the feature item is an item indicating a state, performance, or specification, it is conceivable to include feature items having the feature values of the highest ranking. In addition, in a case where the feature item is an item indicating a function, it is conceivable to include the feature items having the feature value of “presence”. As a result, display information for realizing a display content when selecting a candidate device on the screen based on the instruction information and includes the feature item selected for the selected candidate device is generated.

Next, the display information generation unit 43 focuses on one candidate device among the unselected candidate devices (step S453). Then, the feature items to be included in the screen are selected for the focused candidate device (step S454). Specifically, since the selection display condition definition which defines the condition regarding the feature value for including the feature item on the screen is stored in the definition information storage unit 45, the feature item is selected with reference to the selection display condition definition. For example, in a case where the feature item is an item indicating a state, performance, or specification, it is conceivable to include feature items having the feature values of the highest ranking. In addition, in a case where the feature item is an item indicating a function, it is conceivable to include the feature items having the feature value of “presence”. As a result, display information for realizing a display content when selecting a candidate device on the screen based on the instruction information and includes the feature item selected for the focused candidate device is generated.

Further, in a case where the feature item is an item indicating a state, performance, or specification, the display information generation unit 43 converts the feature value of the feature item into a difference in the feature values of the feature item of the selected candidate device (step S455). Then, it is determined whether or not the difference indicates that the feature value of the focused candidate device (unselected candidate device) is better than the feature value of the selected candidate device (step S456). In a case where it is determined that the difference indicates that the feature value of the focused candidate device (unselected candidate device) is better than the feature value of the selected candidate device, the display information generation unit 43 adds an attribute indicating a favorable feature value to the feature value of the focused candidate device in the display information generated in step S454 (step S457). On the other hand, in a case where it is not determined that the difference indicates that the feature value of the focused candidate device (unselected candidate device) is better than the feature value of the selected candidate device, the display information generation unit 43 adds an attribute indicating that the unfavorable feature value to the feature value of the focused candidate device in the display information generated in step S454 (step S458).

Thereafter, the display information generation unit 43 determines whether or not all unselected candidate devices are focused on in step S453 (step S459). In a case where it is determined that there is a candidate device that is not focused on, the display information generation unit 43 returns the process to step S453. Further, in a case where it is determined that all candidate devices are focused on, the process proceeds to step S460.

Finally, the display information generation unit 43 outputs the display information generated in step Ss 452 and 454 so far to the transmission unit 46 (step S460), and ends the process.

Then, the transmission unit 46 transmits the display information to the client 10. Then, based on the display information, the client 10 realizes the display content when selecting a candidate device on the screen based on the instruction information.

Next, the above-described operation will be specifically described in the case where the candidate device is a printing device and the case where the candidate device is a terminal device.

### First Example

A first example is an example where the candidate device is a printing device.

First, a specific example of definition information stored in advance in the definition information storage unit 45 prior to the operation of FIG. 4 will be described.

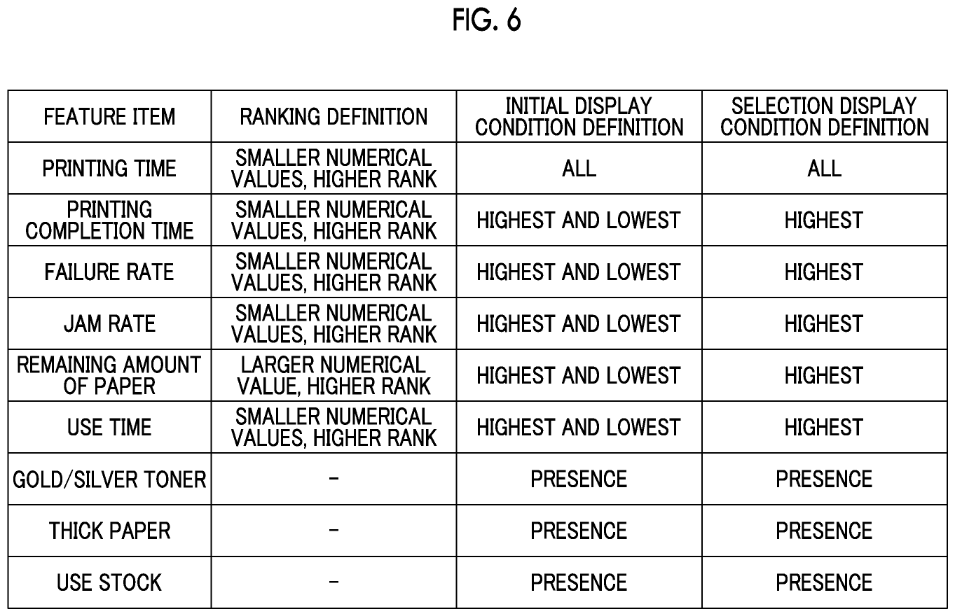

FIG. 6 is a diagram showing a specific example of definition information stored in advance in the definition information storage unit 45. As illustrated, the definition information is obtained by associating feature items, ranking definitions, initial display condition definitions, and selection display condition definition with each other.

The feature item is an item of feature information as described above. Items from “printing time” to “use time” are items indicating states, performance or specifications, and items from “gold/silver toner” to “use stock” are items indicating functions.

The ranking definition defines, as described above, in a case where the feature value of the feature item is represented by a numerical value, whether the larger the numerical value, the higher the ranking, or the smaller the numerical value, the higher the rank. For example, “printing time”, “failure rate”, or the like is defined that the smaller the numerical value, the higher the rank. For example, the “remaining amount of paper” is defined that the larger the value, the higher the rank.

The initial display condition definition is a definition of a condition regarding a feature value for including the feature item in the initial display content of the screen. For example, in the case where the feature item is an item indicating a state, performance, or specification, the basic idea is to display a feature item having a large difference from other candidate devices. Therefore, it is defined that the feature items of the feature values ranked highest and the feature items of the feature values ranked lowest, such as “failure rate” and “remaining amount of paper”, are included in the initial display content of the screen. However, it may be defined that the particularly important feature items such as “printing time” are included in the initial display content on the screen regardless of the feature value. In addition, in a case where the feature items are items indicating a function, the basic idea is to display feature items that can appeal better points than other candidate devices. Therefore, it is defined that a feature item with a feature value of “presence” such as “gold/silver toner” is included in the initial display content of the screen.

The selection display condition definition is a definition of a condition regarding a feature value for including the feature information in the display content when selecting a screen. For example, in the case where the feature items are items indicating a state, performance, or specification, the basic idea is to display feature items that can appeal better points than the selected candidate device. Therefore, it is defined that the feature items of the feature values ranked highest, such as “failure rate” and “remaining amount of paper”, are included in the display content when selecting a candidate device on the screen. However, it may be defined that the particularly important feature items such as “printing time” are included in the display content when selecting the candidate device on the screen regardless of the feature value. In addition, in a case where the feature items are items indicating a function, the basic idea is to display feature items that can appeal better points than the selected candidate device. Therefore, it is defined that a feature item with a feature value of “presence” such as “gold/silver toner” is included in the display content when selecting a candidate device on a screen.

Next, a specific example of the feature information stored in the feature information storage unit 44 in step S404 of FIG. 4 will be described.

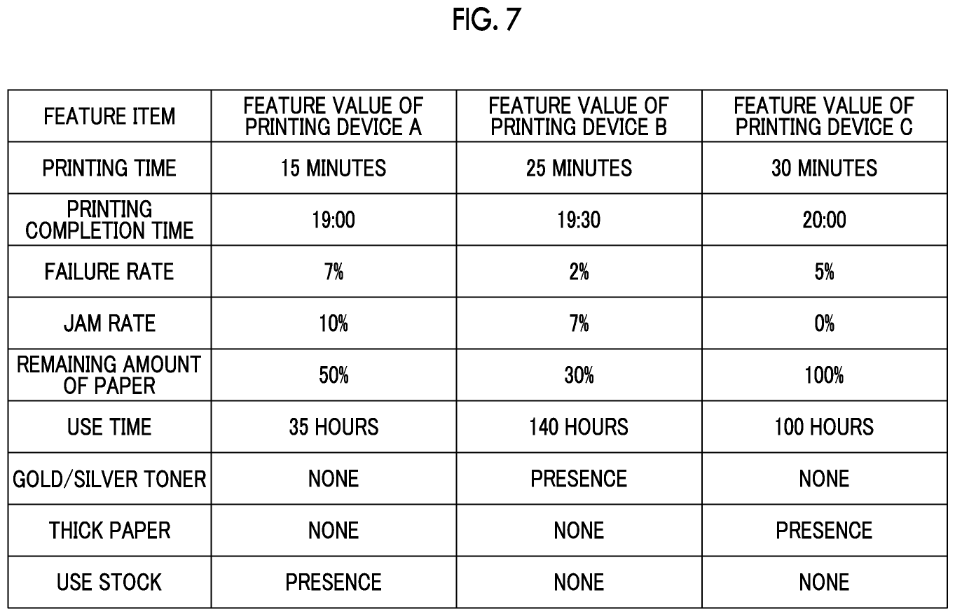

FIG. 7 is a diagram showing a specific example of feature information stored in the feature information storage unit 44 at this time. In FIG. 7, the feature information is obtained by associating feature items with feature values for each printing device.

In a case where the feature item is an item indicating a state, performance, or specification, these feature values are represented by numerical values, and in a case where the feature item is an item indicating a function, these feature values are represented by “presence” or “none”.

Next, a specific example of the feature information stored in the feature information storage unit 44 after the process of ranking or the process of leaving “presence” is performed in step S406 of FIG. 4 will be described.

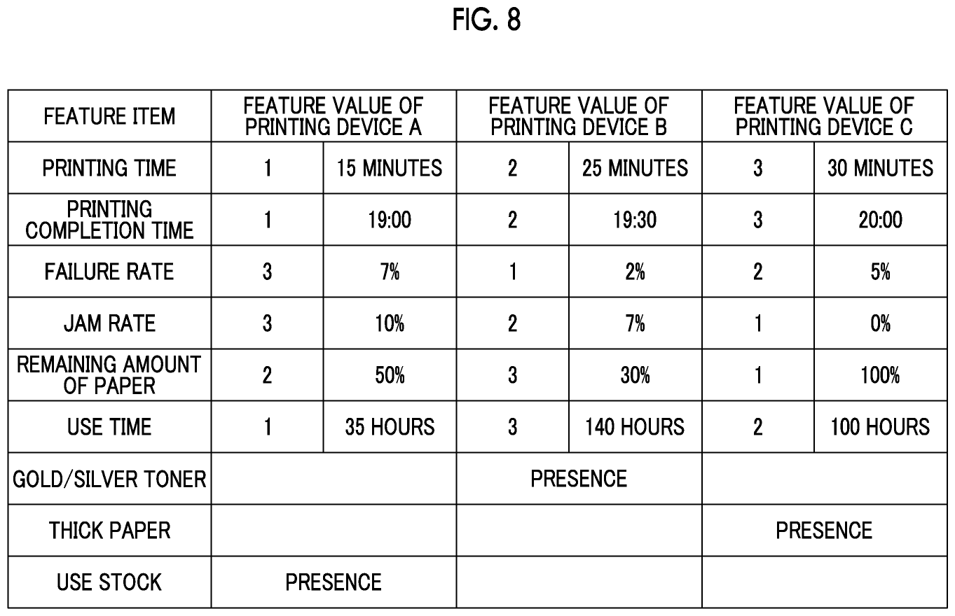

FIG. 8 is a diagram showing a specific example of feature information stored in the feature information storage unit 44 at this time. Even in FIG. 8, the feature information is obtained by associating feature items with feature values for each printing device.

In a case where the feature value of the feature item is represented by a numerical value, the numerical value is ranked. For example, for the “printing time”, a ranking definition indicating that the smaller the value, the higher the rank is stored in the definition information storage unit 45 in FIG. 6, and the feature value of the printing device A, the feature value of the printing device B, and the feature value of the printing device C are stored in ascending order in the feature information storage unit 44 in FIG. 7. Accordingly, in FIG. 8, the ranking “1” is given to the printing device A, the ranking “2” is given to the printing device B, and the ranking “3” is given to the printing device C, respectively. For example, for the “failure rate”, a ranking definition indicating that the smaller the value, the higher the rank is stored in the definition information storage unit 45 in FIG. 6, and the feature value of the printing device B, the feature value of the printing device C, and the feature value of the printing device A are stored in ascending order in the feature information storage unit 44 in FIG. 7. Accordingly, in FIG. 8, the ranking “1” is given to the printing device B, the ranking “2” is given to the printing device C, and the ranking “3” is given to the printing device A, respectively. For example, for the “remaining amount of paper”, a ranking definition indicating that the larger the value, the higher the rank is stored in the definition information storage unit 45 in FIG. 6, and the feature value of the printing device C, the feature value of the printing device A, and the feature value of the printing device B are stored in descending order in the feature information storage unit 44 in FIG. 7. Accordingly, the ranking “1” is given to the printing device C, the ranking “2” is given to the printing device A, and the ranking “3” is given to the printing device B, respectively.

In addition, in a case where the feature value of the feature item is represented as “presence” or “none”, only the feature value “present” is left. For example, with respect to “gold/silver toner”, the feature value “none” of the printing device A and the feature value “none” of the printing device C are deleted.

Next, the initial display contents of the print instruction screen 21 displayed on the client 10 based on the display information output in step S410 of FIG. 4 will be described.

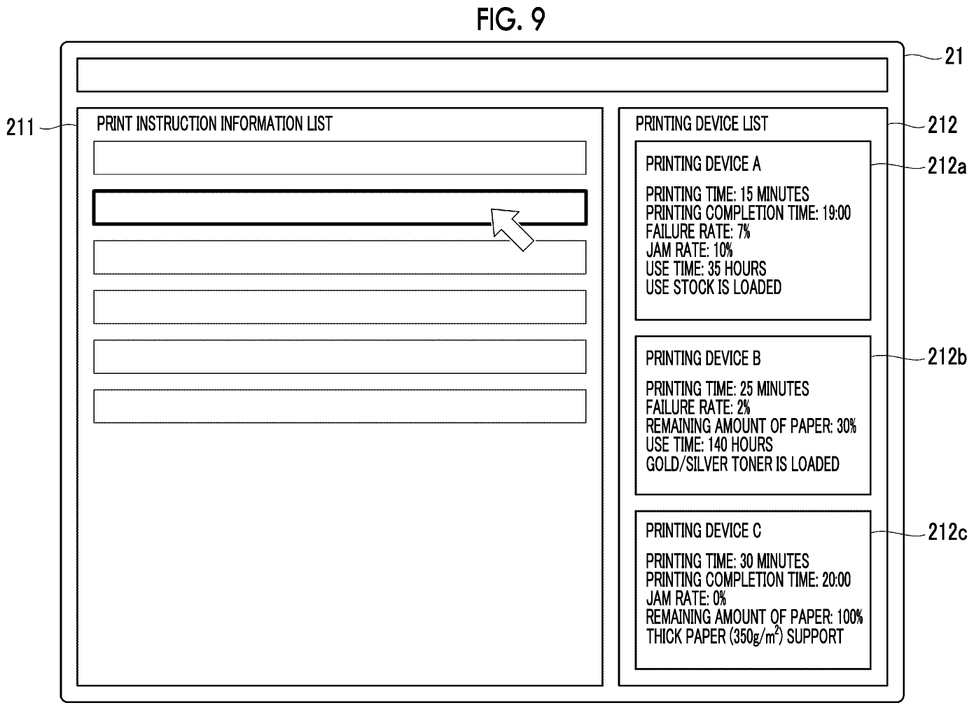

FIG. 9 is a diagram showing an example of initial display contents of a print instruction screen 21 displayed on the client 10. As illustrated, the print instruction screen 21 includes a print instruction information list display area 211 and a printing device list display area 212.

It is assumed that the user selects the print instruction information surrounded by a thick line, from the print instruction information list display area 211, as indicated by a white arrow. Then, a list of printing devices capable of printing the selected print instruction information is displayed in the printing device list display area 212. Here, a list of printing devices A, B, and C is displayed in the printing device list display area 212. Then, in the printing device list display area 212, a feature information display area 212a for displaying feature information of the printing device A, a feature information display area 212b for displaying feature information of the printing device B, and a feature information display area 212c for displaying feature information of the printing device C are provided.

In the feature information display area 212a, “printing time” in which the initial display condition definition in the definition information storage unit 45 of FIG. 6 is “all” is displayed. Further, “printing completion time”, “failure rate”, “jam rate”, and “use time” in which the initial display condition definition in the definition information storage unit 45 of FIG. 6 is “highest and lowest”, and the ranking of the feature value of the printing device A in the feature information storage unit 44 of FIG. 8 is “1” or “3” are displayed. Further, “use stock” is displayed in which the initial display condition definition in the definition information storage unit 45 of FIG. 6 is “presence” and the feature value of the printing device A in the feature information storage unit 44 of FIG. 8 is “presence”.

In the feature information display area 212b, “printing time” in which the initial display condition definition in the definition information storage unit 45 of FIG. 6 is “all” is displayed. Further, “failure rate”, “remaining amount of paper”, and “use time” in which the initial display condition definition in the definition information storage unit 45 of FIG. 6 is “highest and lowest”, and the ranking of the feature value of the printing device B in the feature information storage unit 44 of FIG. 8 is “1” or “3” are displayed. Further, “gold/silver toner” is displayed in which the initial display condition definition in the definition information storage unit 45 of FIG. 6 is “presence” and the feature value of the printing device B in the feature information storage unit 44 of FIG. 8 is “presence”.

In the feature information display area 212c, “printing time” in which the initial display condition definition in the definition information storage unit 45 of FIG. 6 is “all” is displayed. Further, “printing completion time”, “jam rate” and “remaining amount of paper” in which the initial display condition definition in the definition information storage unit 45 of FIG. 6 is “highest and lowest”, and the ranking of the feature value of the printing device C in the feature information storage unit 44 of FIG. 8 is “1” or “3” are displayed. Further, “thick paper” is displayed in which the initial display condition definition in the definition information storage unit 45 of FIG. 6 is “presence” and the feature value of the printing device C in the feature information storage unit 44 of FIG. 8 is “presence”.

Next, a description will be made about the display contents of the print instruction screen 21 displayed on the client 10 based on the display information output in step S460 of FIG. 5, by selecting the printing device A on the print instruction screen 21 of FIG. 9.

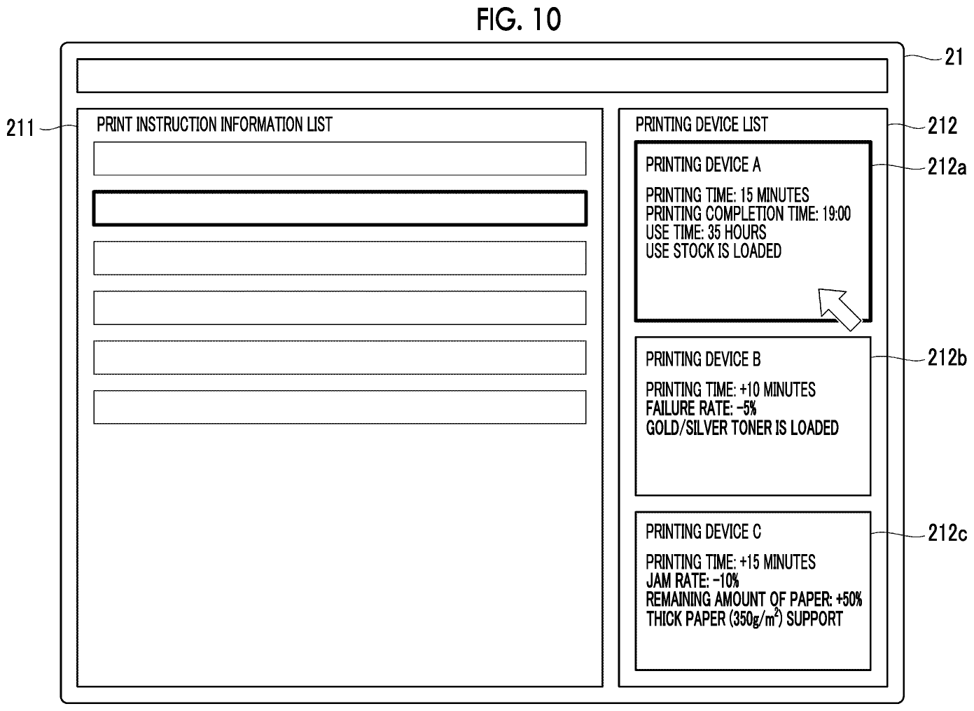

FIG. 10 is a diagram showing an example of display contents when selecting a printing device A on the print instruction screen 21 displayed on the client 10.

It is assumed that the user selects a feature information display area 212a surrounded by a thick line from the printing device list display area 212 as indicated by a white arrow. Then, the feature information of the printing device B which is not selected is displayed in the feature information display area 212b, based on the feature information of the selected printing device A. Further, the feature information of the printing device C which is not selected is displayed in the feature information display area 212c, based on the feature information of the selected printing device A.

In the feature information display area 212a, “printing time” in which the selection display condition definition in the definition information storage unit 45 of FIG. 6 is “all” is displayed. Further, “printing completion time” and “use time” in which the selection display condition definition in the definition information storage unit 45 of FIG. 6 is “highest”, and the ranking of the feature value of the printing device A in the feature information storage unit 44 of FIG. 8 is “1” are displayed. Further, “use stock” is displayed in which the selection display condition definition in the definition information storage unit 45 of FIG. 6 is “presence” and the feature value of the printing device A in the feature information storage unit 44 of FIG. 8 is “presence”.

In the feature information display area 212b, “printing time” in which the selection display condition definition in the definition information storage unit 45 of FIG. 6 is “all” is displayed. However, “printing time” is shown to be 10 minutes longer than “printing time” of the printing device A, and small texts indicate that the printing time is not better than the “printing time” of the printing device A. Further, “failure rate” in which the selection display condition definition in the definition information storage unit 45 of FIG. 6 is “highest”, and the ranking of the feature value of the printing device B in the feature information storage unit 44 of FIG. 8 is “1” is displayed. However, the “failure rate” is shown to be 5% lower than the “failure rate” of the printing device A, and bold texts indicate that the failure rate is better than the “failure rate” of the printing device A. Further, “gold/silver toner” is displayed in which the selection display condition definition in the definition information storage unit 45 of FIG. 6 is “presence” and the feature value of the printing device B in the feature information storage unit 44 of FIG. 8 is “presence”. Here, bold texts indicate that it is better than the printing device A that “gold/silver toner” is loaded.

In the feature information display area 212c, “printing time” in which the selection display condition definition in the definition information storage unit 45 of FIG. 6 is “all” is displayed. However, “printing time” is shown to be 15 minutes longer than “printing time” of the printing device A, and small texts indicate that the printing time is not better than “printing time” of the printing device A. Further, “jam rate” and “remaining amount of paper” in which the selection display condition definition in the definition information storage unit 45 of FIG. 6 is “highest”, and the ranking of the feature value of the printing device C in the feature information storage unit 44 of FIG. 8 is “1” are displayed. However, the “jam rate” is shown to be 10% lower than the “jam rate” of the printing device A, and bold texts indicate that the jam rate is better than the “jam rate” of the printing device A. However, the “remaining amount of paper” is shown to be 50% more than the “remaining amount of paper” of the printing device A, and bold texts indicate that the remaining amount of paper is better than the “remaining amount of paper” of the printing device A. Further, “thick paper” is displayed in which the selection display condition definition in the definition information storage unit 45 of FIG. 6 is “presence” and the feature value of the printing device C in the feature information storage unit 44 of FIG. 8 is “presence”. Here, bold texts indicate that it is better than the printing device A that “thick paper” is loaded.

Next, a description will be made about the display contents of the print instruction screen 21 displayed on the client 10 based on the display information output in step S460 of FIG. 5, by selecting the printing device B on the print instruction screen 21 of FIG. 9.

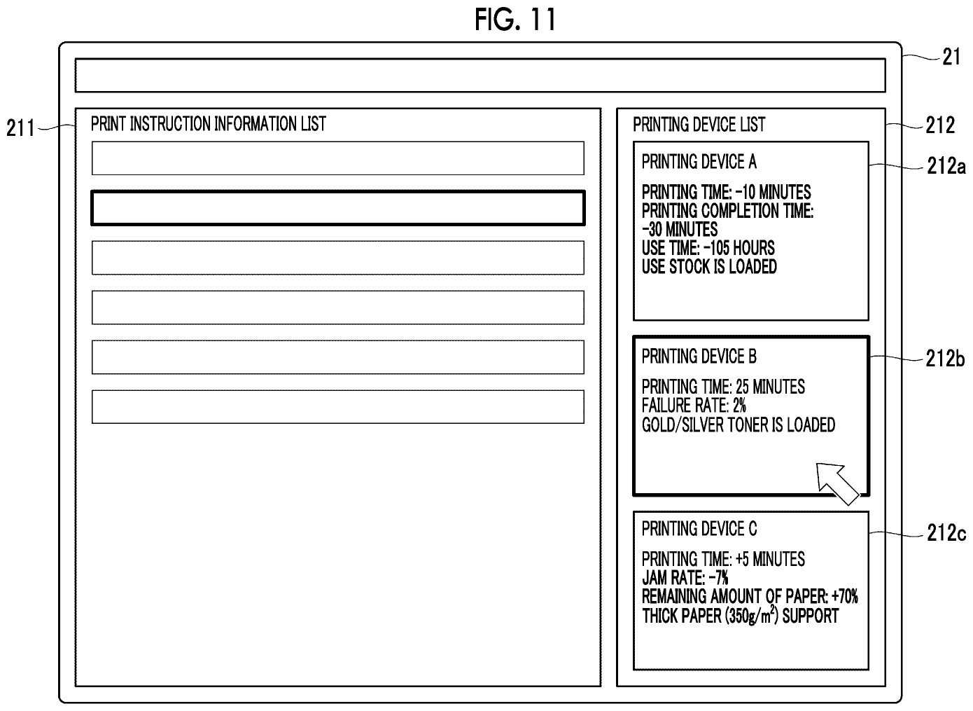

FIG. 11 is a diagram showing an example of display contents when selecting a printing device B on the print instruction screen 21 displayed on the client 10.

It is assumed that the user selects a feature information display area 212b surrounded by a thick line from the printing device list display area 212 as indicated by a white arrow. Then, the feature information of the printing device A which is not selected is displayed in the feature information display area 212a, based on the feature information of the selected printing device B. Further, the feature information of the printing device C which is not selected is displayed in the feature information display area 212c, based on the feature information of the selected printing device B.

In the feature information display area 212b, “printing time” in which the selection display condition definition in the definition information storage unit 45 of FIG. 6 is “all” is displayed. Further, “failure rate” in which the selection display condition definition in the definition information storage unit 45 of FIG. 6 is “highest”, and the ranking of the feature value of the printing device B in the feature information storage unit 44 of FIG. 8 is “1” is displayed. Further, “gold/silver toner” is displayed in which the selection display condition definition in the definition information storage unit 45 of FIG. 6 is “presence” and the feature value of the printing device B in the feature information storage unit 44 of FIG. 8 is “presence”.

In the feature information display area 212a, “printing time” in which the selection display condition definition in the definition information storage unit 45 of FIG. 6 is “all” is displayed. However, “printing time” is shown to be 10 minutes shorter than “printing time” of the printing device B, and bold texts indicate that the printing time is better than “printing time” of the printing device B. Further, “printing completion time” and “use time” in which the selection display condition definition in the definition information storage unit 45 of FIG. 6 is “highest”, and the ranking of the feature value of the printing device A in the feature information storage unit 44 of FIG. 8 is “1” are displayed. However, “printing completion time” is shown to be 30 minutes earlier than the “printing completion time” of the printing device B, and bold texts indicate that the printing completion time is better than the “printing completion time” of the printing device B. However, “use time” is shown to be 105 hours shorter than “use time” of the printing device B, and bold texts indicate that the use time is better than the “use time” of the printing device B. Further, “use stock” is displayed in which the selection display condition definition in the definition information storage unit 45 of FIG. 6 is “presence” and the feature value of the printing device A in the feature information storage unit 44 of FIG. 8 is “presence”. Here, bold texts indicate that it is better than the printing device B that “use stock” is loaded.

In the feature information display area 212c, “printing time” in which the selection display condition definition in the definition information storage unit 45 of FIG. 6 is “all” is displayed. However, “printing time” is shown to be 5 minutes longer than “printing time” of the printing device B, and small texts indicate that the printing time is not better than the “printing time” of the printing device B. Further, “jam rate” and “remaining amount of paper” in which the selection display condition definition in the definition information storage unit 45 of FIG. 6 is “highest”, and the ranking of the feature value of the printing device C in the feature information storage unit 44 of FIG. 8 is “1” are displayed. However, the “jam rate” is shown to be 7% lower than the “jam rate” of the printing device B, and bold texts indicate that the jam rate is better than the “jam rate” of the printing device B. However, the “remaining amount of paper” is shown to be 70% more than the “remaining amount of paper” of the printing device B, and bold texts indicate that the remaining amount of paper is better than the “remaining amount of paper” of the printing device B. Further, “thick paper” is displayed in which the selection display condition definition in the definition information storage unit 45 of FIG. 6 is “presence” and the feature value of the printing device C in the feature information storage unit 44 of FIG. 8 is “presence”. Here, bold texts indicate that it is better than the printing device B that “thick paper” is loaded.

In a case where the printing device to be selected in this way is changed, the feature information of the unselected printing device is also changed.

Although the names of the feature items stored in the feature information storage unit 44 of FIG. 8 are basically included as the names are in the display contents of the print instruction screen 21, in FIGS. 9 to 11, the present invention is not limited thereto. For example, in a case where the feature values are represented by numerical values, the feature values may be included in the display contents of the print instruction screen 21 respectively, by adding the word such “maximum” or “longest” to the names of the feature items for the largest value, and adding the word such “minimum” or “shortest” to the names of the feature items for the shortest value.

Further, in FIGS. 10 and 11, whether the feature information of the unselected printing device is better or is not better than the feature information of the selected printing device is distinguished by the thickness of the texts, but the present invention is not limited thereto. For example, it may be distinguished by the color of a text.

### Second Example

A second example is an example where the candidate device is a terminal device. Here, among the terminal devices, a mobile terminal, in particular, a smartphone will be described as an example.

First, a specific example of definition information stored in advance in the definition information storage unit 45 prior to the operation of FIG. 4 will be described.

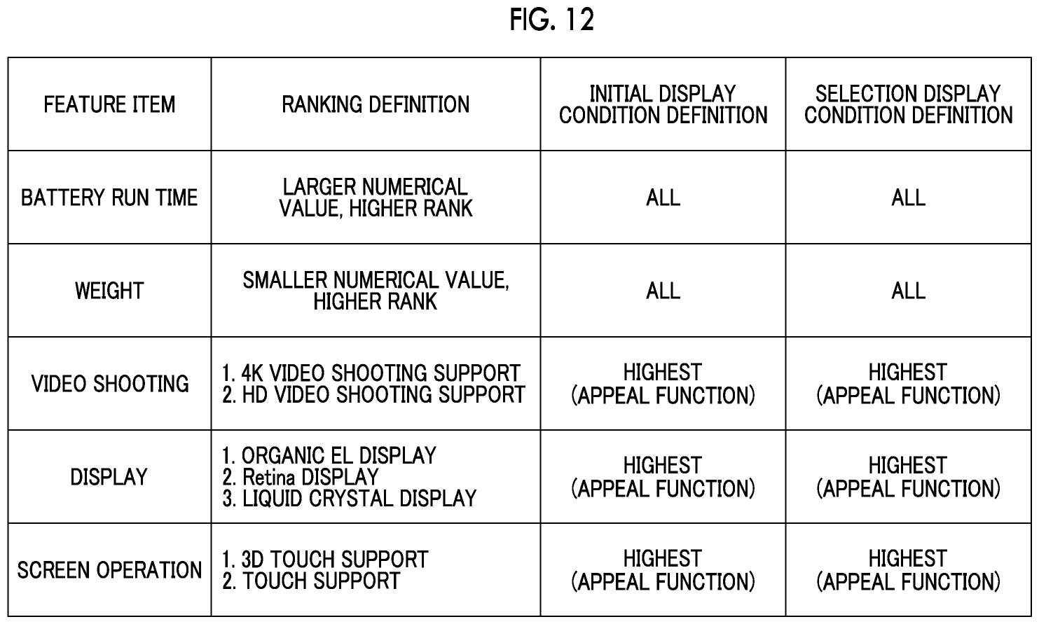

FIG. 12 is a diagram showing a specific example of definition information stored in advance in the definition information storage unit 45. As illustrated, the definition information is obtained by associating feature items, ranking definitions, initial display condition definitions, and selection display condition definition with each other.

The feature item is an item of feature information as described above. “battery run time” and “weight” are items indicating the state, performance, or specification, and “video shooting”, “display”, and “screen operation” are items indicating functions.

The ranking definition defines, as described above, in a case where the feature value of the feature item is represented by a numerical value, whether the larger the numerical value, the higher the rank, or the smaller the numerical value, the higher the rank. For example, the “battery run time” is defined that the larger the value, the higher the rank. For example, the “weight” is defined that the smaller the value, the higher the rank. Further, as described above, in a case where the feature value of the feature item is represented by the type of function, it is defined which function is ranked high. For example, “video shooting” is defined as “4K video shooting support” and “HD video shooting support” from the top ranking. For example, “display” is defined as “organic EL display”, “Retina display”, and “liquid crystal display” from the top ranking. For example, “screen operation” is defined as “3D touch support” and “touch support” from the top ranking.

The initial display condition definition is a definition of a condition regarding a feature value for including the feature item in the initial display content of the screen. For example, in the case where the feature item is an item indicating a state, performance, or specification, the basic idea is to display a feature item regardless of the feature value. Therefore, it is defined that “battery run time” and “weight” are included in the initial display content of the screen regardless of the feature value. In addition, in a case where the feature items are items indicating a function, the basic idea is to display the feature items that can appeal best function. Therefore, it is defined that “video shooting”, “display”, and “screen operation” are included in the initial display content of the screen in a case where the feature value is ranked highest. In addition, the phrase “appeal function” in parentheses means that these feature items are displayed as the “appeal function” items.

The selection display condition definition is a definition of a condition regarding a feature value for including the feature information in the display content when selecting a screen. For example, in the case where the feature item is an item indicating a state, performance, or specification, the basic idea is to display a feature item regardless of the feature value. Therefore, it is defined that “battery operation time” and “weight” are included in the display content when selecting the screen, regardless of the feature value. In addition, in a case where the feature items are items indicating a function, the basic idea is to display the feature items that can appeal best function. Therefore, it is defined that “video shooting”, “display”, and “screen operation” are included in the display content when the screen is selected in a case where the feature value is ranked highest. In addition, the phrase “appeal function” in parentheses means that these feature items are displayed as the “appeal function” items.

Next, a specific example of the feature information stored in the feature information storage unit 44 in step S404 of FIG. 4 will be described.

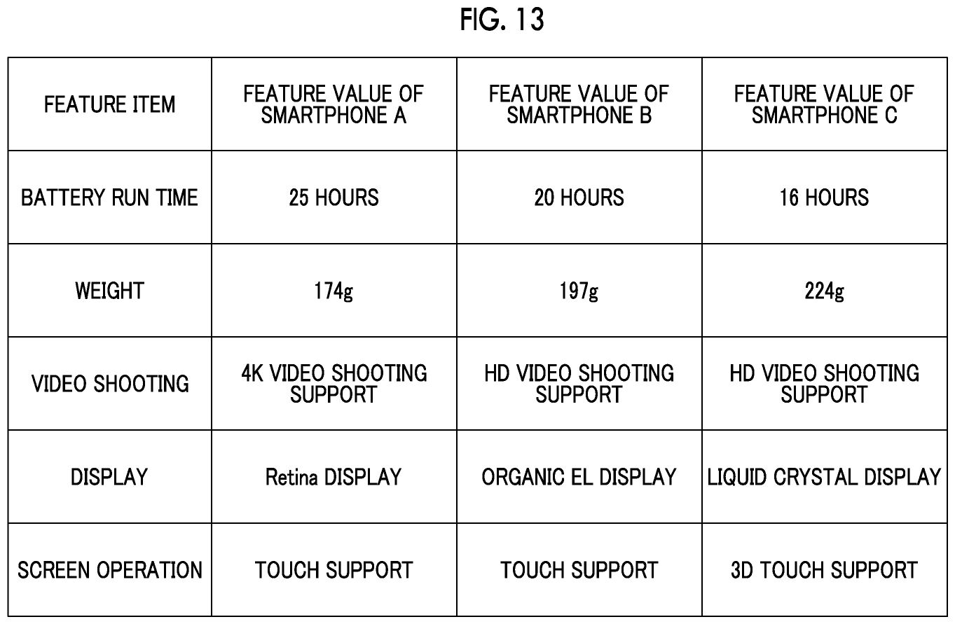

FIG. 13 is a diagram showing a specific example of the feature information stored in the feature information storage unit 44 at this time. In FIG. 13, the feature information is obtained by associating feature items with feature values for each smartphone.

In a case where the feature item is an item indicating a state, performance, or specification, these feature values are represented by numerical values, and in a case where the feature item is an item indicating a function, these feature values are represented by types of functions.

Next, a specific example of the feature information stored in the feature information storage unit 44 after the process of ranking or the process of leaving “presence” is performed in step S406 of FIG. 4 will be described.

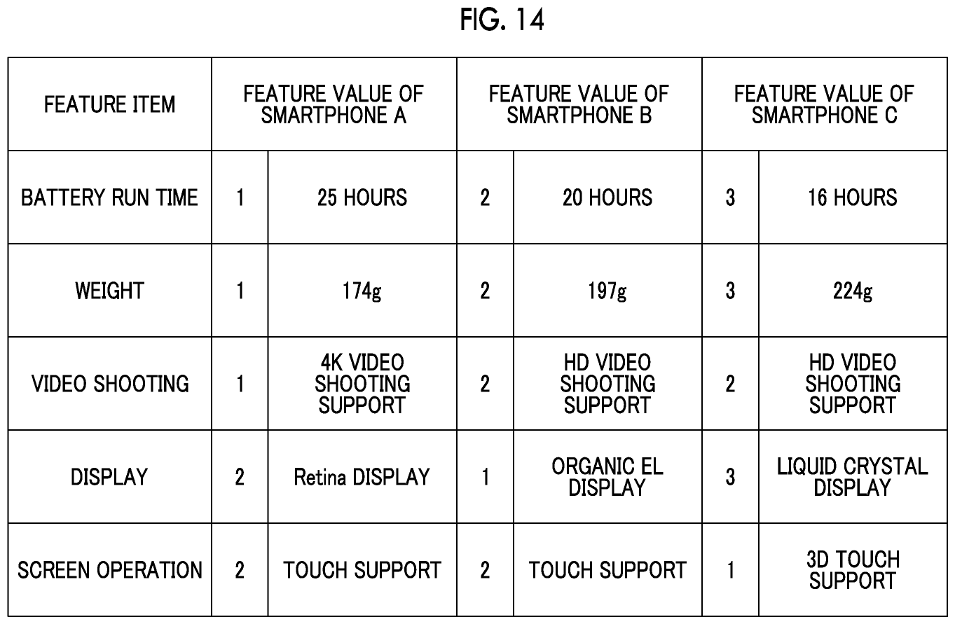

FIG. 14 is a diagram showing a specific example of the feature information stored in the feature information storage unit 44 at this time. Even in FIG. 14, the feature information is obtained by associating feature items with feature values for each smartphone.

In a case where the feature value of the feature item is represented by a numerical value, the numerical value is ranked. For example, for “battery run time”, a ranking definition indicating that the larger the value, the higher the rank is stored in the definition information storage unit 45 in FIG. 12, and the feature value of the smartphone A, the feature value of the smartphone B, and the feature value of the smartphone C are stored in descending order in the feature information storage unit 44 in FIG. 13. Accordingly, in FIG. 14, the ranking “1” is given to the smartphone A, the ranking “2” is given to the smartphone B, and the ranking “3” is given to the smartphone C, respectively. For example, for “weight”, a ranking definition indicating that the smaller the value, the higher the rank is stored in the definition information storage unit 45 in FIG. 12, and the feature value of the smartphone A, the feature value of the smartphone B, and the feature value of the smartphone C are stored in ascending order in the feature information storage unit 44 in FIG. 13. Accordingly, in FIG. 14, the ranking “1” is given to the smartphone A, the ranking “2” is given to the smartphone B, and the ranking “3” is given to the smartphone C, respectively.

Further, in a case where the feature value of the feature item is represented by the type of function, the type of function is ranked. For example, ranking definition that “video shooting” is defined as “4K video shooting support” and “HD video shooting support” from the top ranking is stored in the definition information storage unit 45 of FIG. 12, and the feature information storage unit 44 of FIG. 13 stores that the feature value of the smartphone A is “4K video shooting support”, and the feature values of the smartphones B, C are “HD video shooting support”. Accordingly, in FIG. 14, the ranking “1” is given to the smartphone A, and the ranking “2” is given to the smartphones B, C, respectively. For example, ranking definition that “display” is defined as “organic EL display”, “Retina display”, and “liquid crystal display” from the top ranking is stored in the definition information storage unit 45 of FIG. 12, and the feature information storage unit 44 of FIG. 13 stores that the feature value of the smartphone A is “Retina display”, the feature value of the smartphone B is “organic EL display”, and the feature value of the smartphone C is “liquid crystal display”. Accordingly, in FIG. 14, the ranking “2” is given to the smartphone A, the ranking “1” is given to the smartphone B, and the ranking “3” is given to the smartphone C, respectively. For example, ranking definition that “screen operation” is defined as “3D touch support” and “touch support” from the top ranking is stored in the definition information storage unit 45 of FIG. 12, and the feature information storage unit 44 of FIG. 13 stores that the feature values of the smartphones A, B are “touch support”, and the feature value of the smartphone C is “3D touch support”. Accordingly, in FIG. 14, the ranking “1” is given to the smartphones A, B, and the ranking “2” is given to the smartphone C, respectively.

Next, the initial display contents of the search result screen 22 displayed on the client 10 based on the display information output in step S410 of FIG. 4 will be described.

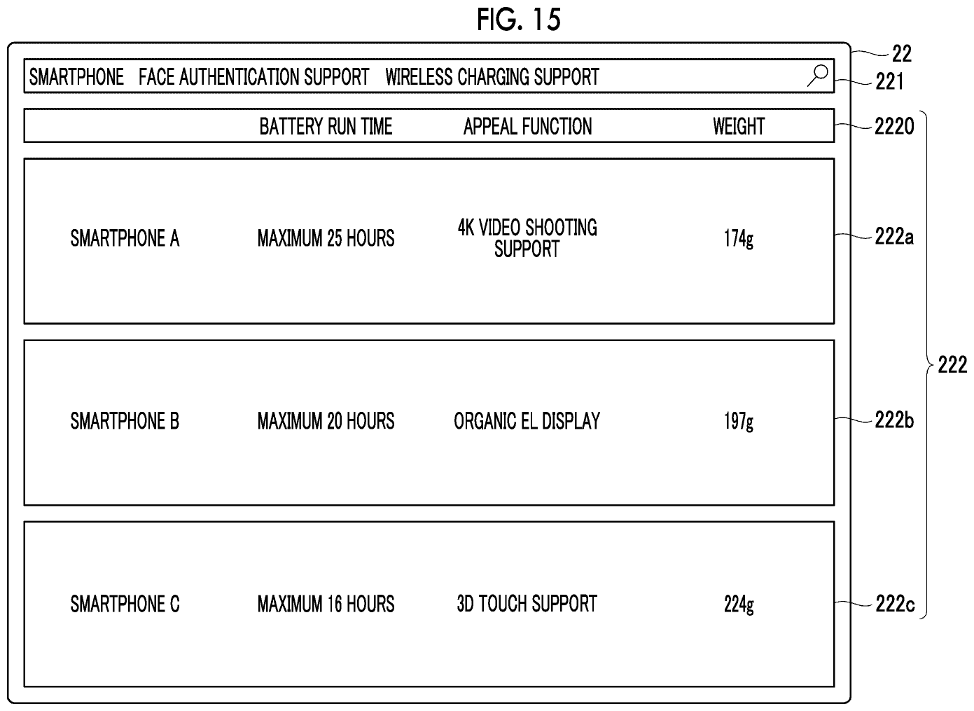

FIG. 15 is a diagram showing an example of initial display contents of the search result screen 22 displayed on the client 10. As illustrated, the search result screen 22 includes a search word input field 221 and a smartphone list display area 222.

It is assumed that a user inputs a search word “smartphone, face authentication support, wireless charging” in the search word input field 221.

Then, a list of smartphones matching the search word is displayed in the smartphone list display area 222. Here, a list of smartphones A, B, and C is displayed in the smartphone list display area 222. In the smartphone list display area 222, a feature item display area 2220 for displaying feature items of the smartphone, a feature value display area 222a for displaying feature values of the smartphone A, a feature value display area 222b for displaying feature values of the smartphone B, and a feature value display area 222c for displaying feature values of the smartphone C are provided.

In the feature item display area 2220, feature items “battery run time” and “weight” for which the initial display condition definition in the definition information storage unit 45 of FIG. 12 is “all” are displayed. Further, the feature items “video shooting”, “display”, and “screen operation” in which the initial display condition definition in the definition information storage unit 45 of FIG. 12 is “highest (appeal function)” are displayed collectively in one feature item “appeal function”.

In the feature value display area 222a, feature values of the “battery run time” and “weight” for which the initial display condition definition in the definition information storage unit 45 of FIG. 12 is “all” are displayed. Further, the failure value of “video shooting” in which the initial display condition definition in the definition information storage unit 45 of FIG. 12 is “highest (appeal function)”, and the ranking of the feature value of the smartphone A in the feature information storage unit 44 of FIG. 14 is “1” is displayed as “appeal function”.

In the feature value display area 222b, feature values of the “battery run time” and “weight” for which the initial display condition definition in the definition information storage unit 45 of FIG. 12 is “all” are displayed. Further, the failure value of “display” in which the initial display condition definition in the definition information storage unit 45 of FIG. 12 is “highest (appeal function)”, and the ranking of the feature value of the printing device B in the feature information storage unit 44 of FIG. 14 is “1” is displayed as “appeal function”.

In the feature value display area 222c, feature values of the “battery run time” and “weight” for which the initial display condition definition in the definition information storage unit 45 of FIG. 12 is “all” are displayed. Further, the failure value of “screen operation” in which the initial display condition definition in the definition information storage unit 45 of FIG. 12 is “highest (appeal function)”, and the ranking of the feature value of the printing device C in the feature information storage unit 44 of FIG. 14 is “1” is displayed as “appeal function”.

Here, assuming that the smartphone A is an example of a first device among the plural devices, the smartphone B or the smartphone C is an example of a second device different from the first device among the plural devices, and the feature item “video shooting” is an example of the first function. Here, assuming that the smartphone B is an example of a second device, the feature item “display” is an example of the second function different from the first function, and assuming that the smartphone C is an example of the second device, the feature item “screen operation” is an example of a second function different from the first function. Further, the feature item “appeal function” is an example of a specific item, and the display information generation unit 43 is an example of a generation section that generates display information for a displaying feature related to the first function in a specific item in association with the first device, and a feature related to the second function in a specific item in association with the second device.

Next, a description will be made about the display contents of the search result screen 22 displayed on the client 10 based on the display information output in step S460 of FIG. 5, by selecting the smartphone A on the search result screen 22 of FIG. 15.

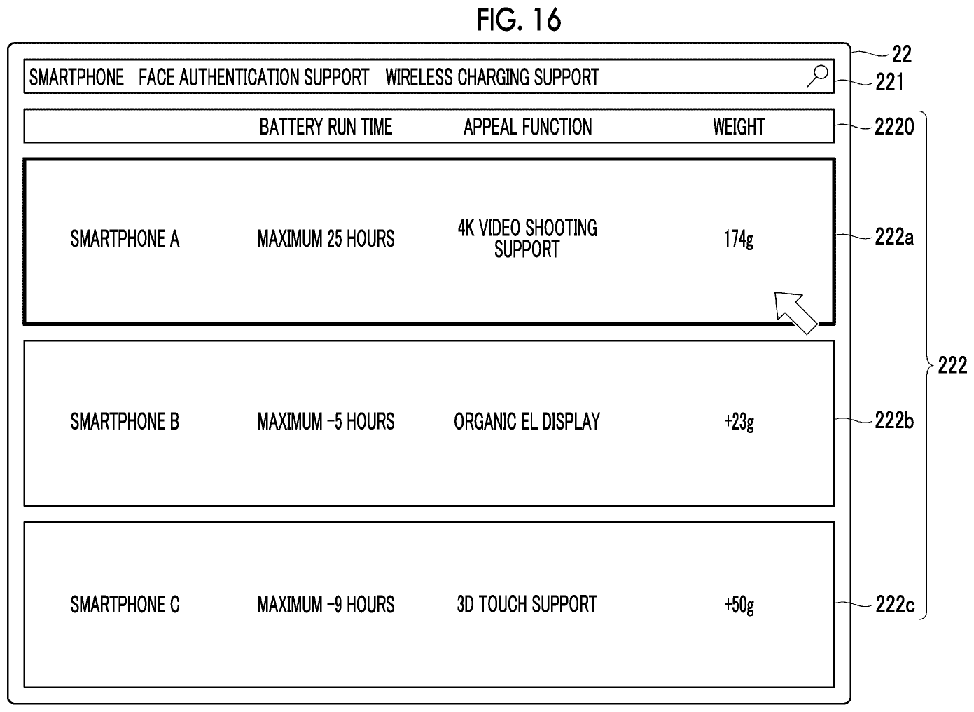

FIG. 16 is a diagram showing an example of display contents when the smartphone A is selected on the search result screen 22 displayed on the client 10.

It is assumed that the user selects a feature value display area 222a surrounded by a thick line from the smartphone list display area 222 as indicated by a white arrow. Then, the feature information of the smartphone B which is not selected is displayed in the feature value display area 222b, based on the feature information of the selected smartphone A. Further, the feature information of the smartphone C which is not selected is displayed in the feature value display area 222c, based on the feature information of the selected smartphone A.

In the feature value display area 222a, the “battery run time” and “weight” for which the selection display condition definition in the definition information storage unit 45 of FIG. 12 is “all” are displayed. Further, the failure value of “video shooting” in which the selection display condition definition in the definition information storage unit 45 of FIG. 12 is “highest (appeal function)”, and the ranking of the feature value of the smartphone A in the feature information storage unit 44 of FIG. 14 is “1” is displayed as “appeal function”.

In the feature value display area 222b, the “battery run time” and “weight” for which the selection display condition definition in the definition information storage unit 45 of FIG. 12 is “all” are displayed. However, it is shown that “the battery run time” is 5 hours shorter than the “battery run time” of the smartphone A, and small texts indicate that the battery run time is not better than the “battery run time” of the smartphone A. It is shown that “weight” is 23 g heavier than the “weight” of the smartphone A, and small texts indicate that the weight is not better than the “weight” of the smartphone A. Further, the failure value of “display” in which the selection display condition definition in the definition information storage unit 45 of FIG. 12 is “highest (appeal function)”, and the ranking of the feature value of the printing device B in the feature information storage unit 44 of FIG. 14 is “1” is displayed as “appeal function”.

In the feature value display area 222c, the “battery run time” and “weight” for which the selection display condition definition in the definition information storage unit 45 of FIG. 12 is “all” are displayed. However, it is shown that “the battery run time” is 9 hours shorter than the “battery run time” of the smartphone A, and small texts indicate that the battery run time is not better than the “battery run time” of the smartphone A. It is shown that “weight” is 50 g heavier than the “weight” of the smartphone A, and small texts indicate that the weight is not better than the “weight” of the smartphone A. Further, the failure value of “screen operation” in which the selection display condition definition in the definition information storage unit 45 of FIG. 12 is “highest (appeal function)”, and the ranking of the feature value of the printing device C in the feature information storage unit 44 of FIG. 14 is “1” is displayed as “appeal function”.

Although the names of the feature items stored in the feature information storage unit 44 of FIG. 14 are basically included as the names are in the display contents of the search result screen 22 in FIGS. 15 and 16, the present invention is not limited thereto. For example, in a case where the feature values are represented by numerical values, the feature values may be included in the display contents of the search result screen 22 respectively, by adding the word such “maximum” or “longest” to the names of the feature items for the largest value, and adding the word such “minimum” or “shortest” to the names of the feature items for the shortest value.

Further, in FIG. 16, whether or not the feature information of the unselected smartphone is not better than the feature information of the selected smartphone is distinguished by the thickness of the texts, but the present invention is not limited thereto. For example, it may be distinguished by the color of a text.

Here, in the search result screen 22 shown in FIG. 15 or 16, in a case where the “battery run time” in the feature item display area 2220 is pressed, the feature information of the smartphones A, B, C may be rearranged in ascending order of battery run time, or in a case where the “weight” in the feature item display area 2220 is pressed, the feature information may be rearranged in descending order of weight.

Further, for example, in a case where the “appeal function” in the feature item display area 2220 is pressed, the search result screen 22 may be a display content in which the appeal functions of the smartphones A, B, C are emphasized.

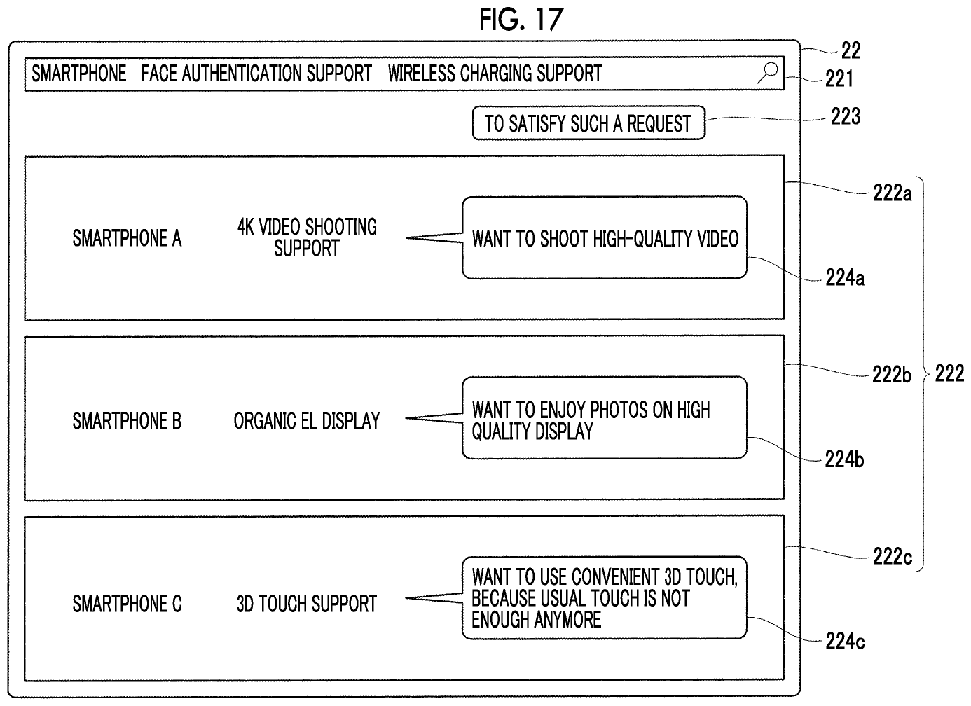

FIG. 17 is a diagram showing an example of display content in which the appeal function of the smartphone on the search result screen 22 at this time is emphasized.

In the feature value display area 222a, the feature value “4K video shooting support” of the feature item “video shooting” which is displayed as the “appeal function” in FIG. 15 or 16 is emphasized and displayed. For the heading 223 “to satisfy such a request”, a message 224a showing what type of request “4K video shooting correspondence” specifically corresponds to is displayed.

In the feature value display area 222b, the feature value “organic EL display” of the feature item “display” which is displayed as the “appeal function” in FIG. 15 or 16 is emphasized and displayed. For the heading 223 “to satisfy such a request”, a message 224b showing what type of request “organic EL display” specifically corresponds to is displayed.

In the feature value display area 222c, the feature value “3D touch support” of the feature item “screen operation” which is displayed as the “appeal function” in FIG. 15 or 16 is emphasized and displayed. For the heading 223 “to satisfy such a request”, a message 224c showing what type of request “3D touch support” specifically corresponds to is displayed.

Program

Here, the process performed by the server 30 in the present exemplary embodiment is prepared as a program such as application software.

That is, the program for realizing the present embodiment is regarded as a program for realizing a function of specifying a plurality of features that each device of plural devices has; and a function of generating display information for displaying a specific feature that at least one device other than each device does not have, among the plurality of features that each device has, in association with each device of the plurality of devices.

Further, the program realizing the present exemplary embodiment can be provided not only by a communication unit but also by being stored in a recording medium such as a CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display information generation device comprising:
a specifying section that specifies a plurality of features that each device of a plurality of devices has; and
a generation section that generates display information for displaying a specific feature that at least one device other than each device does not have, among the plurality of features that each device has, in association with each device of the plurality of devices.

2. The display information generation device according to claim 1,
wherein the generation section generates the display information for displaying a feature satisfying a condition predetermined as a condition indicating a favorable feature, as the specific feature.

3. The display information generation device according to claim 2,
wherein the generation section generates the display information for displaying the feature satisfying the predetermined condition, in a mode predetermined as a mode for expressing the favorable feature.

4. The display information generation device according to claim 1,
wherein the generation section generates the display information for displaying a feature satisfying a condition predetermined as a condition indicating an unfavorable feature, as the specific feature.

5. The display information generation device according to claim 4,
wherein the generation section generates the display information for displaying the feature satisfying the predetermined condition, in a mode predetermined as a mode for expressing that the unfavorable feature.

6. The display information generation device according to claim 1,
wherein the specific feature is a feature related to a state, performance, or a specification that each device of the plurality of devices has.

7. The display information generation device according to claim 6,
wherein the generation section generates the display information for displaying a numerical value that represents the state, the performance, or the specification and satisfies a condition predetermined as a condition indicating a large value, as the feature related to the state, the performance, or the specification.

8. The display information generation device according to claim 6,
wherein the generation section generates the display information for displaying a numerical value that represents the state, the performance, or the specification and satisfies a condition predetermined as a condition indicating a small value, as the feature related to the state, the performance, or the specification.

9. The display information generation device according to claim 6,
wherein in a case where a specific device is selected among the plurality of devices, the generation section generates, in association with another device other than the specific device, the display information for displaying a difference between the numerical value representing the state, the performance, or the specification that the other device has and the numerical value representing the state, the performance, or the specification that the specific device has, as the feature related to the state, the performance, or the specification.

10. The display information generation device according to claim 1,
wherein the specific feature includes a feature related to a function that each device of the plurality of devices has.

11. The display information generation device according to claim 10,
wherein the generation section generates the display information for displaying a fact having the function or a type of the function, as the feature related to the function.

12. The display information generation device according to claim 10,
wherein the generation section generates the display information for displaying a feature related to a first function in a specific item, in association with a first device among the plurality of devices, and a feature related to a second function different from the first function in the specific item, in association with a second device different from the first device among the plurality of devices, as the feature related to the function.

13. A non-transitory computer readable medium storing a program causing a computer to realize:
a function of specifying a plurality of features that each device of a plurality of devices has; and
a function of generating display information for displaying a specific feature that at least one device other than each device does not have, among the plurality of features that each device has, in association with each device of the plurality of devices.

14. A display information generation device comprising:
specifying means for specifying a plurality of features that each device of a plurality of devices has; and
generation means for generating display information for displaying a specific feature that at least one device other than each device does not have, among the plurality of features that each device has, in association with each device of the plurality of devices.
